(19) United States
(12) Patent Application Publication
(10) Pub. No.: US 2020/0222891 A1
(43) Pub. Date: Jul. 16, 2020

(54) ELECTRICALLY HEATED CATALYST

(71) Applicant: DENSO CORPORATION, Kariya-city (JP)

(72) Inventors: Junichi NARUSE, Kariya-city (JP); Takehiro TOKUNO, Kariya-city (JP); Kazuki HIRATA, Kariya-city (JP); Yasushi TAKAYAMA, Kariya-city (JP)

(21) Appl. No.: 16/831,932

(22) Filed: Mar. 27, 2020

Related U.S. Application Data
(63) Continuation of application No. PCT/JP2018/034547, filed on Sep. 19, 2018.

(30) Foreign Application Priority Data
Sep. 29, 2017 (JP) 2017-190315

(51) Int. Cl. B01J 35/04; C04B 38/00; F01N 3/20; B01D 53/88

(52) U.S. Cl. CPC B01J 35/04; C04B 38/0009; B01D 2255/90; B01D 53/885; F01N 3/2026

(57) ABSTRACT

An electrically heated catalyst includes a honeycomb substrate, an electrode, and a joining section. The honeycomb substrate and the joining section include matrices and conductive fillers. The matrices contain borosilicate including at least one of an alkali metal and an alkaline earth metal. The joining section preferably has a softening point lower than that of the honeycomb substrate.

### CROSS-REFERENCE TO RELATED APPLICATION

This application is a U.S. application under 35 U.S.C. 111(a) and 363 that claims the benefit under 35 U.S.C. 120 from International Application No. PCT/JP2018/034547 filed on Sep. 19, 2018, the entire contents of which are incorporated herein by reference. This application is also based on Japanese Patent Application No. 2017-190315 filed on Sep. 29, 2017, the description of which is incorporated herein by reference.

### BACKGROUND

### Technical Field

The present disclosure relates to an electrically heated catalyst.

### Background Art

There has been known an electrically heated catalyst which includes a catalyst-supporting honeycomb substrate formed of SiC or other resistive heating element and is caused to heat through electrical heating for example, in the field of vehicle.

### SUMMARY

According to an aspect of the present disclosure, an electrically heated catalyst includes:

a honeycomb substrate;

an electrode; and

a joining section that joins the honeycomb substrate and the electrode together, wherein

the honeycomb substrate and the joining section include matrices and conductive fillers, and the matrices contain borosilicate including at least one of an alkali metal and an alkaline earth metal.

It is noted that reference signs within parentheses in the claims indicate the correspondence with specific parts mentioned in an embodiment described later, and do not limit the technical scope of the present disclosure.

### BRIEF DESCRIPTION OF THE DRAWINGS

The above and other objects, features, and advantages of the present disclosure will be clearly apparent from the detailed description provided below with reference to the accompanying drawings, in which:

FIG. 1 is a perspective view of an electrically heated catalyst according to a first embodiment;

FIG. 2 is a partial cross-sectional view of the electrically heated catalyst according to the first embodiment;

FIG. 3 is a schematic diagram of the microstructure of a honeycomb substrate according to a first embodiment;

FIG. 4 is a schematic diagram of the microstructure of a joining section according to the first embodiment;

FIG. 5 is a partial cross-sectional view of an electrically heated catalyst according to a second embodiment;

FIG. 6 is a schematic diagram of the microstructure of an electrode according to the second embodiment; and

FIG. 7 is a partial cross-sectional view of an electrically heated catalyst according to a third embodiment.

### DETAILED DESCRIPTION OF THE PREFERRED EMBODIMENTS

The inventor of the present disclosure has studied an electrically heated catalyst that suppresses generation of temperature distribution in its honeycomb substrate for following reasons.

JP 2013-198887 A describes an electrically heated catalyst including a SiC honeycomb substrate and a SiC—Si electrode joined to the substrate with a bonding agent. Hereinafter, the honeycomb substrate is sometimes referred to as the substrate.

However, SiC has a relatively high electrical resistance and thus consumes more power during passage of electricity through the substrate. As a result, an electrically heated catalyst used in, for example, a vehicle reduces the fuel efficiency. It is now desired to develop a honeycomb substrate formed of a resistive heating element with an electrical resistance lower than that of SiC. The present inventors have focused on a honeycomb substrate that includes a matrix containing borosilicate and a resistive heating element containing conductive filler.

For a substrate formed from a different material, an electrode appropriate for the substrate and a brazing material for joining the electrode to the substrate are to be developed. Such a brazing material may be a brazing metal in view of electrical conductivity.

However, metal is easily oxidized, for example, at high temperatures. The oxidation may form a dielectric film of metallic oxide on the brazing metal. The formed dielectric film may cause a localized increase in the electrical resistance.

The increase in the electrical resistance interferes with sufficient passage of electricity through the overall honeycomb substrate, causing the honeycomb substrate to heat insufficiently. More specifically, in this case, passage of electricity cannot easily cause the honeycomb substrate to heat uniformly, leading to a temperature distribution of the electrically heated catalyst. The unevenness in temperature may vary the catalytic activity of the electrically heated catalyst. Moreover, the temperature unevenness in the substrate may cause cracks in the joining section between the substrate and the electrode due to a difference in thermal expansion.

An object of the present disclosure is to provide an electrically heated catalyst that suppresses generation of temperature distribution in its honeycomb substrate.

According to an aspect of the present disclosure, an electrically heated catalyst includes:

a honeycomb substrate;

an electrode formed on the honeycomb substrate; and

a joining section that joins the honeycomb substrate and the electrode together, wherein

the honeycomb substrate and the joining section include matrices and conductive fillers, and the matrices contain borosilicate including at least one of an alkali metal and an alkaline earth metal.

The electrically heated catalyst includes the honeycomb substrate, the electrode, and the joining section for joining both together. The honeycomb substrate and the joining section both include the borosilicate-containing matrices and the conductive fillers, and the borosilicate includes at least one of the alkali metal and the alkaline earth metal. This structure eliminates the need for a brazing metal used as the joining section, allowing the joining section to be free of metal or contain a sufficiently smaller amount of metal.

Thus, for example, metal oxidation of the joining section at high temperatures can be suppressed. Accordingly, for example, formation of a dielectric film of metallic oxide on the joining section at the interface between the joining section and the honeycomb substrate is suppressed.

As a result, increase in the electrical resistance of the joining section at localized areas is suppressed, thus allowing electricity to sufficiently flow through the honeycomb substrate by passing an electric current through the electrode. The electrically heated catalyst thus heats efficiently. In other words, the overall honeycomb substrate is allowed to heat uniformly during electrical heating, without localized heating in some parts such as the joining section. As a result, generation of unevenness in the catalytic activity is prevented. Additionally, generation of a difference in thermal expansion is suppressed and thus cracking in the joining section are prevented.

As described above, the honeycomb substrate and the joining section are formed from the same materials. Thus, the honeycomb substrate and the joining section have little difference in thermal expansion. This contributes to the prevention of damage caused by a difference in thermal expansion. In addition, the honeycomb substrate and the joining section have a high affinity, improving their bonding strength.

Since the matrices of the honeycomb substrate and the joining section contain the alkali metal and/or the alkaline earth metal, a lower electrical resistance of the matrices can be achieved. Thus, the joining section is allowed to have an electrical resistance lower than that of the honeycomb substrate by, for example, selecting low-electric-resistivity fillers as the conductive fillers in the honeycomb substrate and the joining section and increasing the conductive filler content in the joining section compared with the honeycomb substrate. As a result, the honeycomb substrate is efficiently heated while suppressing heating in the joining section.

The matrix of the honeycomb substrate has an electric resistivity having small temperature dependence compared with SiC and exhibiting PTC characteristics. Thus, when the conductive filler contained in the honeycomb substrate has an electric resistivity exhibiting PTC characteristics, the electric resistivity of the honeycomb substrate greatly exhibits PTC characteristics. In contrast, when the conductive filler has an electric resistivity exhibiting NTC characteristics, the electric resistivity of the matrix, exhibiting PTC characteristics, is combined with the electric resistivity of the conductive filler, exhibiting NTC characteristics, to allow the honeycomb substrate to have an electric resistivity having small temperature dependence and exhibiting PTC characteristics or having almost no temperature dependence. The same applies to the joining section.

As described above, since the honeycomb substrate may be formed for its electric resistivity not to exhibit NTC characteristics, a concentration of current flow into a relatively high-temperature area during electrical heating can be avoided. Thus, temperature distribution in the honeycomb substrate and the joining section are less likely to generate and cracking due to a difference in thermal expansion are less likely to occur because localized heating only in a relatively high-temperature area is suppressed. Although SiC can be subjected to electrical heating with a small amount of current to prevent cracking due to a difference between coefficients of thermal expansion, it takes time to sufficiently heat.

Furthermore, since the matrix of the honeycomb substrate contains the alkali metal and/or the alkaline earth metal, the matrix can have a lower electrical resistance. Thus, the electric resistivity of the honeycomb substrate is easily lowered by, for example, selecting low-electric-resistivity filler as the conductive filler and increasing the filler content. Accordingly, the honeycomb substrate advantageously has a low electrical resistance and an electric resistivity having small temperature dependence compared with a honeycomb substrate formed entirely of the matrix or formed of SiC.

With the honeycomb substrate having the structure described above, the electrically heated catalyst is less likely to have temperature distribution during electrical heating. Accordingly, the electrically heated catalyst is less likely to crack due to uneven catalytic activity and a difference in thermal expansion. In addition, the honeycomb substrate heats earlier at a lower temperature during electrical heating.

As described above, according to the above aspect, there provided an electrically heated catalyst that suppresses generation of temperature distribution in its honeycomb substrate.

### First Embodiment

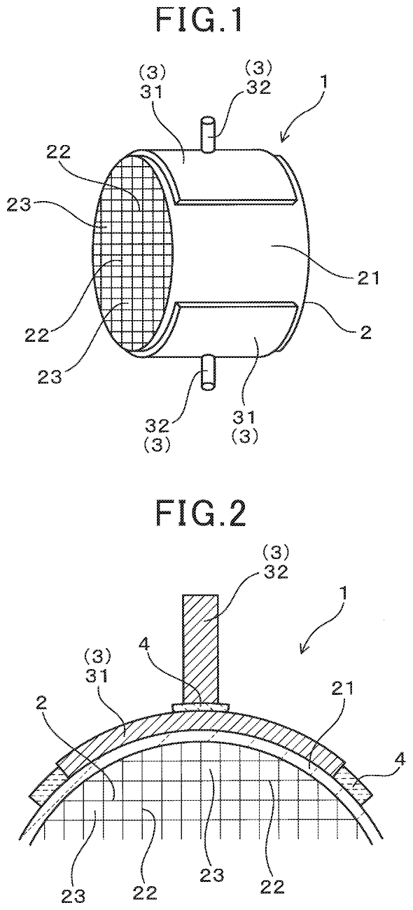

An embodiment for an electrically heated catalyst will now be described with reference to FIGS. 1 to 4. The electrically heated catalyst described herein may have a catalyst supported on a substrate or no catalyst supported on the substrate (i.e., a carrier). An electrically heated catalyst is sometimes referred to as an EHC. As illustrated in FIGS. 1 and 2, an electrically heated catalyst 1 includes a honeycomb substrate 2, an electrode 3, and a joining section 4.

The honeycomb substrate 2, which has a honeycomb structure, may include a cylindrical outer skin 21 and a large number of cell walls 22 partitioning the inside of the outer skin 21. The honeycomb substrate 2 includes a large number of cells 23 surrounded by the cell walls 22 and extending in the axial direction. The honeycomb substrate 2 may have any shape such as, but not limited to, a column with the outer skin 21 cylindrical as illustrated in FIGS. 1 and 2. Each cell 23 may have any cross-section such as, but not limited to, a quadrangle. The honeycomb substrate 2 may have a known structure.

The electrode 3 is formed on, for example, the outer skin 21 of the honeycomb substrate 2. Typically, a pair of electrodes 3 may be formed on the outer skin to pass electricity through the honeycomb substrate 2. The pair of the electrodes 3 may be arranged, for example, on the outer skin 21 facing each other. As illustrated in FIGS. 1 and 2, each electrode 3 includes a tile-shaped electrode 31 and a rod-shaped electrode 32. The tile-shaped electrodes 31 sit opposite to each other, with the rod-shaped electrodes 32 also opposite to each other.

The honeycomb substrate 2 and each electrode 3 are joined with the joining section 4. The embodiment for the electrically heated catalyst 1 will be further described in detail below.

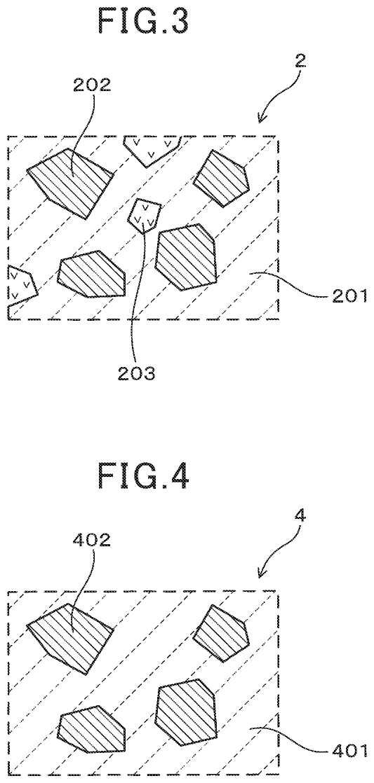

As illustrated in FIG. 3, the honeycomb substrate 2 includes a matrix 201 and conductive filler 202. The matrix 201 may be amorphous or crystalline. For the matrix 201 that is amorphous, the conductive filler 202 is dispersed in the matrix 201, for example, in the form of particles. In other words, the honeycomb substrate 2 may have a microstructure that is a sea-island structure in which the matrix 201 is “sea” and the conductive filler 202 is “islands.”

The matrix 201 contains borosilicate. The borosilicate includes at least one of an alkali metal and an alkaline earth metal. More specifically, the matrix 201 contains borosilicate doped with the alkali metal and/or the alkaline earth metal. In the honeycomb substrate 2 with this structure, the matrix 201, which is the base material, determines the electrical resistance during electrical heating.

The matrix 201 has an electric resistivity having a smaller temperature dependence compared with, for example, SiC and exhibiting positive temperature coefficient (PTC) characteristics. Thus, when the conductive filler 202 contained in the matrix 201 has an electric resistivity exhibiting PTC characteristics, the honeycomb substrate 2 has an electric resistivity having small temperature dependence and exhibiting PTC characteristics. In contrast, when the conductive filler 202 has an electric resistivity exhibiting negative temperature coefficient (NTC) characteristics, the electric resistivity of the matrix 201, exhibiting PTC characteristics, is combined with the electric resistivity of the conductive filler 202, exhibiting NTC characteristics, to allow the honeycomb substrate 2 to have an electric resistivity having small temperature dependence and exhibiting PTC characteristics or having almost no temperature dependence. Accordingly, during electrical heating, an internal temperature distribution and a cracking due to a difference in thermal expansion are less likely to occur in the honeycomb substrate 2. In addition, the honeycomb substrate 2 heats earlier and at a lower temperature during electrical heating.

The borosilicate may contain at least one of an alkali metal and an alkaline earth metal. In other words, the borosilicate may be doped with at least one of an alkali metal and an alkaline earth metal. As the alkali metal or the alkaline earth metal, at least one selected from the group consisting of Na, Mg, K, Ca, Li, Be, Rb, Sr, Cs, Ba, Fr, and Ra is preferably used. The selected metal will lower the electrical resistance of the matrix 201. Thus, the electric resistivity of the honeycomb substrate 2 is easily lowered by selecting low-electric-resistivity filler as the conductive filler 202 and increasing the filler content.

In order to easily lower the electrical resistance of the honeycomb substrate 2, the borosilicate preferably contains at least one selected from the group consisting of Na, Mg, K, and Ca. More preferably, the borosilicate contains at least one of Na and K or both Na and K. The borosilicate may be more specifically aluminoborosilicate.

The borosilicate may contain 0.1 mass % or more and 10 mass % or less of an alkali metal and an alkaline earth metal in total. The percentages reliably allow the matrix 201 to have a lower electrical resistance. The percentages also reliably allow the matrix 201 to have an electric resistivity having small temperature dependence compared with SiC and exhibiting PTC characteristics. When the borosilicate contains one alkali metal or one alkaline earth metal, the phrase “an alkali metal and an alkaline earth metal in total” means the percentage by mass of the alkali metal or the alkaline earth metal. When the borosilicate contains multiple alkali metals, multiple of alkaline earth metals, or both (an) alkali metal(s) and (an) alkaline earth metal(s), the above phrase means the combined total percentage by mass of the contained elements.

In order to ensure the effects of the addition of an alkali metal and an alkaline earth metal, the total alkali metal and alkaline earth metal content is preferably 0.2 mass % or more, more preferably 0.5 mass % or more, and still more preferably 0.8 mass % or more. In order to prevent deformation caused by a decrease in the softening point of the matrix 201, the total alkali metal and alkaline earth metal content is preferably 8 mass % or less, more preferably 5 mass % or less, and still more preferably 3 mass % or less.

The borosilicate may contain 15 mass % or more and 40 mass % or less of Si. In this case, the electric resistivity of the borosilicate containing the alkali metal and/or the alkaline earth metal tends to exhibit PTC characteristics.

In order to ensure the effects described above and raise the softening point of the matrix 201, the Si content is preferably 5 mass % or more, more preferably 10 mass % or more, and still more preferably 15 mass % or more.

In order to ensure the effects described above, the Si content is also preferably 30 mass % or less, more preferably 25 mass % or less, and still more preferably 22 mass % or less.

The borosilicate may contain 0.1 mass % or more by 15 mass % or less by mass of B. This content advantageously allows PTC characteristics to be exhibited.

In order to ensure the effects described above, the B content is preferably 0.5 mass % or more, more preferably 1 mass % or more, and still more preferably 1.5 mass % or more. In order to ensure the effects described above, the B content is also preferably 12 mass % or less, more preferably 10 mass % or less, and still more preferably 8 mass % or less.

The borosilicate may contain 40 mass % or more and 80 mass % or less of O. This content advantageously allows PTC characteristics to be exhibited.

In order to ensure the effects described above, the O content is preferably 45 mass % or more, more preferably 50 mass % or more, still more preferably 60 mass % or more, and yet still more preferably 70 mass % or more. In order to ensure the effects described above, the O content is also preferably 82 mass % or less, more preferably 80 mass % or less, and still more preferably 78 mass % or less.

The element contents of the borosilicate can be selected within the above ranges so as to total 100 mass %. When all the total alkali metal and alkaline earth metal content and the Si, B, and O contents in the borosilicate fall within the above corresponding ranges, the honeycomb substrate 2 reliably has an electric resistivity having small temperature dependence and exhibiting PTC characteristics or having substantially no temperature dependence. Examples of other elements that can be contained in the borosilicate of the matrix 201 also include Al, Fe, and C.

In case the borosilicate contains Al, the Al content is preferably 1 mass % or more, more preferably 2 mass % or more, and still more preferably 3 mass % or more in order to ensure the effects described above. In order to ensure the effects described above, the Al content is preferably 8 mass % or less, more preferably 6 mass % or less, and still more preferably 5 mass % or less. The element contents are measured with an electron probe microanalyzer (or EPMA) (JXA-8500F, manufactured by JEOL Ltd, or another electron probe microanalyzer capable of the same measurement if JXA-8500F has gone out of production and is unavailable).

The honeycomb substrate 2 further contains the conductive filler 202. Accordingly, by compositing the matrix 201 and the conductive filler 202, the electric resistivity of the overall PTC resistive heating element is determined by combining the electric resistivity of the matrix 201 with the electric resistivity of the conductive filler 202. Thus, the content and electrical conductivity of the conductive filler 202 can be modified to control the electric resistivity of the honeycomb substrate 2. It is noted that the electric resistivity of the conductive filler 202 may exhibit any of PTC characteristics and NTC characteristics, or have no temperature dependence.

The conductive filler 202 is not limited as long as particles have electrical conductivity, and the conductive filler 202 is preferably electronically conductive particles that contain Si. The conductive particles that contain Si are hereinafter referred to as Si-containing particles.

Specific examples of Si-containing particles include Si particles, Fe—Si-based particles, Si—W-based particles, Si—C-based particles, Si—Mo-based particles, and Si—Ti-based particles. One or more types of them may be contained in the honeycomb substrate 2.

In case the honeycomb substrate 2 contains Si-containing particles as the conductive filler 202, the softening point of the base material is easily raised by diffusing Si atoms from the Si-containing particles into the borosilicate around the Si-containing particles. The honeycomb substrate 2 formed of the honeycomb substrate 2 is thus allowed to have improved shape retention. As a result, the cell walls are resistant to deformation even at high temperatures, leading to the increased structural stability of the honeycomb substrate 2. The Si-containing particles are preferably Si particles or Fe—Si-based particles in view of the Si diffusion into the borosilicate.

The honeycomb substrate 2 may specifically contain the matrix 201 and the conductive filler 202 that amount to 50 vol % or more. In particular, the honeycomb substrate 2 containing borosilicate including at least one of an alkali metal and an alkaline earth metal enables the matrix 201 to have a lower electrical resistance, and the matrix 201 also allows passage of electrons. Thus, the matrix 201 and the conductive filler 202 that amount to 50 vol % or more enable the honeycomb substrate 2 to have electrical conductivity more reliably in accordance with known percolation theory. In view of the electrical conductivity due to the formation of percolation, the total content of the matrix 201 and the conductive filler 202 is preferably 52 vol % or more, more preferably 55 vol % or more, still more preferably 57 vol % or more, and yet still more preferably 60 vol % or more.

In the honeycomb substrate 2, electrons flow through the conductive filler 202 and the matrix 201. It is presumed that the honeycomb substrate 2 exhibits PTC characteristics because electrons traveling in the honeycomb substrate 2 are affected by lattice vibration. More specifically, it is assumed that large polarons reported regarding substances such as NaₓWO₃ are generated in the honeycomb substrate 2. It is assumed that the replacement of quadrivalent silicon atoms with trivalent boron causes the atom skeleton to be negatively charged, and the electrons of the alkali metal and/or the alkaline earth metal experience a confinement effect, resulting in the generation of large polarons.

The honeycomb substrate 2, at a temperature range of 25° C. to 500° C., may have an electric resistivity of 0.0001 Ω·m or more and 1 Q·m or less and a rate of increase in electrical resistance of 0.01×10⁻⁶/K or more and 5.0×10⁻⁴/K or less. The honeycomb substrate 2, at a temperature range of 25° C. to 500° C., may also have an electric resistivity of 0.0001 Ω·m or more and 1 Ω·m or less and a rate of increase in electrical resistance of 0 or more and less than 0.01×10⁻⁶/K. With these configurations, the honeycomb substrate 2 is less likely to have internal temperature distribution or cracking due to a difference in thermal expansion during electrical heating. With these configurations, the honeycomb substrate 2 can also be heated quickly at a lower temperature during electrical heating, thus enabling early catalyst activation. When the rate of increase in electrical resistance is 0 or more and less than 0.01×10⁻⁶/K, it can be regarded that the electric resistivity has substantially no temperature dependence.

In view of lowering the electrical resistance of the honeycomb substrate 2, a PTC resistive heating element 20 may have an electric resistivity of preferably 0.5 Ω·m or less, more preferably 0.3 Ω·m or less, much more preferably 0.1 Ω·m or less, still more preferably 0.05 Ω·m or less, yet still more preferably 0.01 Ω·m or less, even yet still more preferably less than 0.01 Ω·m, and most preferably 0.005 Ω·m or less. In order to generate more heat during electrical heating, the honeycomb substrate 2 may have an electric resistivity of preferably 0.0002 Ω·m or more, more preferably 0.0005 Ω·m or more, and still more preferably 0.001 Ω·m or more. With this configuration, a honeycomb substrate can be appropriate for an electrically heated catalyst.

In order to easily suppress temperature distribution during electrical heating, the honeycomb substrate 2 has a rate of increase in electrical resistance of preferably 0.001×10⁻⁶/K or more, more preferably 0.01×10⁻⁶/K or more, and still more preferably 0.1×10⁻⁶/K or more. The rate of increase in electrical resistance of the honeycomb substrate 2 is ideally to remain unchanged because an electric circuit has its optimum electrical resistance value to electrical heating. The rate of increase in electrical resistance is preferably 100×10⁻⁶/K or less, more preferably 10×10⁻⁶/K or less, and still more preferably 1×10⁻⁶/K or less.

The electric resistivity of the honeycomb substrate 2 is the average value of measurements taken by the four-terminal method (n=3). After the electric resistivity of the honeycomb substrate 2 is measured in this manner, the rate of increase in electrical resistance of the honeycomb substrate 2 can be calculated by the method described below. First, the electric resistivity is measured at three temperatures: 50° C., 200° C., and 400° C. The electric resistivity at 50° C. is subtracted from the electric resistivity at 400° C. The obtained value is divided by the temperature difference between 400° C. and 50° C., or 350° C., to calculate the rate of increase in electrical resistance.

The honeycomb substrate 2 preferably further contains aggregate 203. In this case, the strength of the honeycomb substrate can be increased. Examples of the aggregate 203 include mullite, cordierite, anorthite, spinel, sapphirine, and alumina.

The honeycomb substrate 2 may have a catalyst supported on it in accordance with the desired purpose. When the electrically heated catalyst 1 is used for purifying vehicle exhaust gas, a three-way catalyst may be supported. The three-way catalyst may be, but not limited to, a noble metal catalyst such as Pt, Pd, or Rh. The catalyst is not limited to a noble metal catalyst for purifying exhaust gas. Transition metal oxide or perovskite oxide may also be supported.

Preferably, the electrically heated catalyst 1 is used for purifying vehicle exhaust gas, and the catalyst supported on the honeycomb substrate 2 is designed to purify exhaust gas. The electrically heated catalyst 1 used for purifying exhaust gas is desired to have improved performance under exposure in the heating and cooling cycle and, in particular, at high temperatures. In the electrically heated catalyst 1 having the configuration described above, the honeycomb substrate 2 exhibits PTC characteristics, thus preventing a decrease in electrical resistance at high temperatures. This enables an excessive current flow to be avoided during electrical heating. Thus, the honeycomb substrate 2 is less likely to have temperature distribution even at high temperatures.

As illustrated in FIGS. 1 and 2, the honeycomb substrate 2 and the electrode 3 are joined together with the joining section 4. The joining section 4 is formed from the same material as for the honeycomb substrate 2. More specifically, as illustrated in FIG. 4, the joining section 4 includes a matrix 401 and conductive filler 402. The matrix 401 and the conductive filler 402 in the joining section 4 may have a configuration similar to that of the matrix 201 and the conductive filler 202 in the honeycomb substrate 2 described above. The joining section 4 may or may not contain aggregate. The aggregate to be used may be the same as the aggregate used in the honeycomb substrate described above.

The joining section 4 preferably has a softening point lower than that of the honeycomb substrate 2. In this case, when the joining section 4 and the honeycomb substrate 2 are sintered during manufacturing of the electrically heated catalyst 1, the joining section 4 can be sintered before sintering of the honeycomb substrate 2. Thus, a bonding agent serving as a raw material for the joining section 4 can be impregnated into the honeycomb substrate yet to be sintered. In other words, the bonding agent can be sintered after its impregnation into the substrate. This improves the bonding strength of the joining section. The softening points can be measured with a thermomechanical analyzer (TMA). The measurement device may be a TMA7000 manufactured by Hitachi High-Tech Science Corporation. If this model has gone out of production and is unavailable, the softening points are measured with another TMA capable of the same measurement.

In particular, since the honeycomb substrate 2 includes the borosilicate-containing matrix as described above, the honeycomb substrate 2 is easily densified during sintering. If the softening point of the joining section is higher than that of the honeycomb substrate or if their softening points are substantially the same, the bonding agent may not be easily impregnated into the substrate, resulting in insufficient bonding strength. However, the bonding strength can be increased by determining the softening points as described above. It is noted that the honeycomb substrate 2 and the joining section 4 may be sintered in the same firing process. In other words, the honeycomb substrate 2 and the joining section 4 can be sintered by simultaneous firing.

The total concentration of the alkali metal and the alkaline earth metal in the joining section 4 is preferably higher than that of the concentration of the honeycomb substrate 2. In this case, a softening point of the joining section 4 lower than that of the honeycomb substrate 2 can easily be achieved. This allows the bonding strength to be increased as described above. When the borosilicate contains one alkali metal or one alkaline earth metal, the phrase “the total concentration of the alkali metal and the alkaline earth metal” means the concentration of the alkali metal or the alkaline earth metal. When the borosilicate contains multiple alkali metals, multiple alkaline earth metals, or both (an) alkali metal(s) and (an) alkaline earth metal(s), the above phrase means the combined total percentage by mass of the contained elements. For comparison of concentrations, concentrations of alkali metal atoms and alkaline earth metal atoms may be compared, or in some cases, concentrations of alkali metal ions and alkaline earth metal ions may be compared. The concentrations may be compared with the above-described EPMA analyzer.

The total concentration of the alkali metal and the alkaline earth metal in the joining section 4 can be adjusted as appropriate, for example, within a range of 0.1 mass % to 15 mass %. In order to sufficiently lower the softening point of the joining section 4 and sufficiently improve the bonding strength, the total concentration is preferably 1 mass % to 14 mass %, more preferably 2.1 mass % to 12 mass %, and still more preferably 7.2 mass % to 10 mass %. The total concentration of the alkali metal and the alkaline earth metal in the joining section 4 can be measured with the above-mentioned EPMA.

As described above, since the honeycomb substrate 2 is easily densified, the honeycomb substrate 2 has a porosity of, for example, less than 20%. For a honeycomb substrate with less than 20% porosity, the outer skin 21 tends to have a smooth surface. Also, in this case, the bonding strength can be increased by lowering the softening point of the joining section 4.

In order to reduce pressure loss, the porosity of the honeycomb substrate 2 is preferably 5% or more, and more preferably 10% or more. The porosity is measured with a mercury porosimeter based on the principle of mercury porosimetry. As the mercury porosimeter, an AutoPore IV9500 manufactured by Shimadzu Corporation can be used. If this model has gone out of production and is unavailable, the porosity is measured with another mercury porosimeter capable of the same measurement. Measurement conditions are described below.

First, a test piece is cut out from the honeycomb substrate 2. The test piece is rectangular with dimensions of 15 mm by 15 mm in a plane orthogonal to the axial direction of the honeycomb substrate 2 and with an axial length of 20 mm. The axial direction is the direction in which the cells of the honeycomb substrate 2 extend. Then, the test piece is placed in the measurement cell of the mercury porosimeter, and the measurement cell is depressurized. After that, the measurement cell is charged with mercury and pressurized. Based on the applied pressure and the volume of the mercury introduced into the pores of the test piece, the pore size and the pore volume are measured.

The measurement is performed at a pressure ranging from 0.5 to 20,000 psia. It is noted that 0.5 psia corresponds to 0.35×10⁻³ kg/mm², and 20,000 psia corresponds to 14 kg/mm². The porosity is calculated using the relation:

Porosity (%)=total pore volume/(total pore volume+1/true specific gravity of material for honeycomb substrate)×100

A material of the electrode 3 is not limited, and a metal electrode, a carbon electrode, or an electrode formed of the same resistive heating element as the honeycomb substrate or the like can be employed. An electrode formed from the same low resistive heating element as the honeycomb substrate is hereinafter referred to as a low resistive heating electrode as appropriate. An example of the shape of the electrode 3 include, but not limited to, a tile-shape, a plate-shape, and a rod-shape and the like.

The electrically heated catalyst 1 is produced, for example, in a manner described below. In this embodiment, although an example will be described of producing the electrically heated catalyst 1 illustrated in FIG. 1, the electrically heated catalyst 1 may be produced by any other method.

First, an unfired or a calcined honeycomb substrate is prepared. The preparation will now be detailed as an example.

First, borosilicate glass or borosilicate, alkali metal/alkaline earth metal containing substance, and Si-containing substance are mixed to prepare a mixed raw material for the honeycomb substrate. Examples of the alkali metal/alkaline earth metal containing substance include a Na-containing compound such as Na₂CO₃ or Na₂SiO₃, a Mg-containing compound such as MgCO₃ or MgSiO₃, a K-containing compound such as K₂CO₃ or K₂SiO₃, a Ca-containing compound such as CaCO₃ or CaSiO₃, and a Li-containing compound such as Li₂CO₃ or Li₂SiO₃. One of them or a combination of two or more of them may be used. The alkali metal/alkaline earth metal containing substance may contain one alkali metal and/or one alkaline earth metal or two or more alkali metals and/or alkaline earth metals. In the case in which the borosilicate glass or the borosilicate already contains a needed alkali metal and/or alkaline earth metal, the alkali metal/alkaline earth metal containing substance may not be mixed. Examples of the Si-containing substance include the above-mentioned Si-containing conductive filler. In addition, kaolin, silica, bentonite, or other raw materials for aggregate may be mixed.

Then, the mixed raw material is kneaded together with a binder and water. The binder may be, for example, an organic binder such as methylcellulose. The binder content may be, for example, about 2 mass %.

Then, the resultant kneaded material is molded into a desired honeycomb and dried. The molding method may be, but not limited to, extrusion. Thus, a molding having honeycomb shape is obtained. In case an unfired electrode is applied as described later, the unfired electrode may be applied to the molding or to the calcined body obtained by calcining the molding.

Then, an electrode material is prepared. The electrode material may be, for example, metal paste that contains conductive metal. The metal paste is formed by, for example, kneading conductive metal powder together with a binder and water. The binder may be, for example, an organic binder such as methylcellulose. The electrode material may be the same mixed raw material as for the honeycomb substrate as described later in a second embodiment. The electrode material may also be carbon as described in a third embodiment.

Then, the electrode material such as the metal paste is molded into a desired electrode shape and dried. The molding method may be, but not limited to, extrusion or injection molding. Thus, the electrode material is shaped into electrode shapes such as a tile shape and a rod shape. This process provides electrode molding. If the unfired electrodes are applied as described later, the molded electrodes or the calcined body obtained by calcining the electrode moldings may be applied.

Then, a bonding agent is prepared. More specifically, first, borosilicate glass or borosilicate, alkali metal/alkaline earth metal containing substance, and Si-containing substance are mixed to prepare a mixed raw material for the joining section. The mixed raw material for the joining section may be the same as the above-described mixed raw material for the honeycomb substrate. However, the mixed raw material for the joining section may contain more alkali metal and/or alkaline earth metal than those in the mixed raw material for the honeycomb substrate.

Then, the mixed raw material for the joining section is kneaded together with a binder and water to prepare a bonding agent for forming the joining section. The binder may be, for example, an organic binder such as methylcellulose. The binder content may be, for example, about 2 mass %.

Then, the bonding agent is applied to the tile-shaped electrode moldings, and the resultant bonding surfaces are applied to the honeycomb shaped molding. The bonding agent is also applied to the rod-shaped electrode moldings, and the resultant bonding surfaces are applied to the tile-shaped electrode molding. In this manner, an integrated article of the honeycomb molding, the bonding agent, and the electrode moldings is obtained.

Then, the integrated article is fired. The firing conditions may be modified as appropriate in accordance with the sintering conditions of the components constituting the integrated article. The firing may be performed once or, for example, a multiple times. For a multiple times of firing, for example, the firing may be performed in air and then in an atmosphere of an inert gas such as nitrogen gas. The firing temperature may be regulated within an example range from 500° C. to 1500° C. Furthermore, the firing temperature may be changed so that the firing in an atmosphere of an inert gas is performed at a higher temperature than the firing in air. The firing period of time may be adjusted within an example range from 0.1 to 50 hours.

To reduce the electrical resistance of the matrices constituting the honeycomb substrate 2 and the like, the residual oxygen is preferably reduced for prevention of oxidation. The firing atmosphere may be evacuated to create a high vacuum of 1.0×10⁻⁴ Pa or more and then purged with an inert gas for firing. Examples of an atmosphere of an inert gas include a N₂ atmosphere, a helium atmosphere, and an argon atmosphere. In case the firing is performed after calcination, the condition of the calcination may specifically be a condition in air or an atmosphere of an inert gas at calcination temperatures of 500° C. to 700° C. for a calcination period of time from 1 to 50 hours.

As a result of the firing, the honeycomb substrate 2, the joining section 4, and the electrodes 3 are sintered, and each electrode 3 is joined to the honeycomb substrate 2 with the joining section 4. In this manner, the electrically heated catalyst 1 illustrated in FIGS. 1 to 4 is obtained.

As illustrated in FIGS. 1 to 4, the electrically heated catalyst 1 of the present embodiment includes the honeycomb substrate 2, the electrode 3, and the joining section 4 for joining both together. The honeycomb substrate 2 and the joining section 4 include the matrices 201, 401 and the conductive fillers 202, 402. The matrices 201 and 401 each contain borosilicate including at least one of an alkali metal and an alkaline earth metal. This configuration allows the joining section 4 to be free of metal or contain a sufficiently smaller amount of metal.

Thus, for example, metal oxidation of the joining section 4 at high temperatures are prevented. Accordingly, for example, a dielectric film of metallic oxide is prevented from being formed at the interface between the joining section 4 and the honeycomb substrate 2. As a result, increase of the electrical resistance of the joining section 4 is suppressed, thus allowing electricity to sufficiently flow through the honeycomb substrate 2 by passing an electric current through the electrode 3. As a result, generation of temperature distribution in the electrically heated catalyst 1 is suppressed. In other words, the overall honeycomb substrate 2 is allowed to heat uniformly during electrical heating. As a result, generation of unevenness in the catalytic activity is prevented. Additionally, a difference in thermal expansion is suppressed and thus cracking in the joining section 4 is prevented. As described above, the honeycomb substrate 2 and the joining section 4 are formed from the same material. Thus, the honeycomb substrate 2 and the joining section 4 have little difference in thermal expansion. This also contributes to the prevention of damage caused by a difference in thermal expansion. In addition, the honeycomb substrate 2 and the joining section 4 have a high affinity, achieving their great bonding strength.

The matrices 201 and 401 of the honeycomb substrate 2 and the joining section 4 each have an electric resistivity having small temperature dependence compared with SiC and exhibiting the PTC characteristics. Thus, when the conductive fillers 202 and 402 contained in the honeycomb substrate 2 and the joining section 4 each have an electric resistivity exhibiting the PTC characteristics, the electric resistivity of the honeycomb substrate 2 and the joining section 4 has small temperature dependence and exhibits the PTC characteristics. On the other hand, when the conductive fillers 202 and 402 each have an electric resistivity exhibiting NTC characteristics, the electric resistivity of the matrices 201 and 401, exhibiting PTC characteristics, is combined with the electric resistivity of the conductive fillers 202 and 402, exhibiting NTC characteristics, to allow the honeycomb substrate 2 and the joining section 4 to have an electric resistivity having small temperature dependence and exhibiting PTC characteristics or having substantially no temperature dependence. When the electrode 3 is a resistive heating electrode in the second embodiment, the same applies to the electrode 3.

As described above, since the honeycomb substrate 2 and the joining section 4 can be formed for their electric resistivity not to exhibit NTC characteristics, an excessive current flow during electrical heating can be avoided. Thus, in the honeycomb substrate 2 and the joining section 4, temperature distribution and cracking due to a difference in thermal expansion is less likely to occur. Although SiC can be subjected to electrical heating with a small amount of current to prevent cracking due to a difference between coefficients of thermal expansion, it takes time for SiC to sufficiently heat.

Furthermore, since the honeycomb substrate 2 and the joining section 4 each include the matrix containing the alkali metal and/or the alkaline earth metal, the matrices 201 and 401 will have a lower electrical resistance. Thus, the electric resistivity of the honeycomb substrate 2 and the joining section 4 is easily lowered by selecting low-electric-resistivity filler as the conductive fillers 202 and 402 and increasing the filler content. Accordingly, the honeycomb substrate 2 and the joining section 4 advantageously have a lower electrical resistance and an electric resistivity having smaller temperature dependence compared with a material formed entirely of the matrix or SiC. When the electrode 3 is a resistive heating electrode, the same applies to the electrode 3.

With the honeycomb substrate 2 and the joining section 4 having the structure described above, in the electrically heated catalyst 1, temperature distribution inside the substrate and cracking due to a difference in thermal expansion is less likely to occur when the honeycomb substrate 2 is subjected to electrical heating. In addition, the honeycomb substrate 2 heats more quickly and at a lower temperature during electrical heating.

### Second Embodiment

An electrically heated catalyst will now be described including an electrode 3 that is a resistive heating electrode formed from the same material as for the honeycomb substrate and the joining section. In the second and subsequent embodiments, the same reference signs as used in a previous embodiment indicate the same items as described in the previous embodiment, unless otherwise specified.

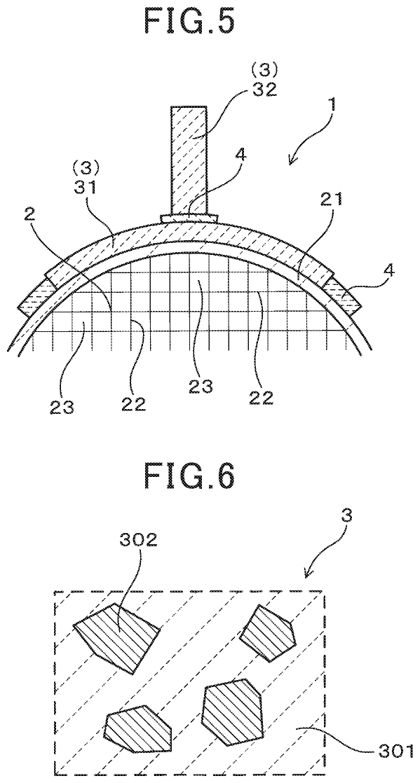

As illustrated in FIGS. 5 and 6, a resistive heating electrode including a matrix 301 and conductive filler 302 can be used as the electrode 3. In this case, the matrix 301 may contain borosilicate including at least one of an alkali metal and an alkaline earth metal. The other parts of the electrically heated catalyst 1 in the present embodiment may be the same as those in the first embodiment. With this configuration, the honeycomb substrate 2, the joining section 4, and the electrode 3 may be formed from the same material. Thus, the difference in thermal expansion can be reduced or eliminated among the honeycomb substrate 2, the joining section 4, and the electrode 3. Accordingly, damage caused by a difference in thermal expansion is more reliably prevented.

In case the electrode 3 includes the matrix 301, the total concentration of the alkali metal and the alkaline earth metal in the electrode 3 is preferably higher than that of the honeycomb substrate 2. This allows a reduction in the electrical resistance of the matrix 301 in the electrode 3. Thus, the electric resistivity of the electrode 3 is easily lowered by selecting low-electric-resistivity filler as the conductive filler 302 and increasing the filler content. The concentrations can be compared with the above-described EPMA analyzer.

The total concentration of the alkali metal and the alkaline earth metal in the electrode 3 is preferably lower than that of the joining section 4. In other words, the total concentration of the alkali metal and the alkaline earth metal in the joining section 4 is preferably higher than that of the electrode 3. In this case, the joining section 4 tends to have a softening point lower than that of the electrode 3. Thus, when the bonding agent for forming the joining section is applied to an unfired electrode 3, and the unfired electrode 3 is applied to an unfired honeycomb substrate and fired, the bonding agent is easily softened during the firing and correspondingly easily impregnated into the electrode 3. In addition, the electrode 3, which is less easily softened than the bonding agent, easily holds the desired shape during the firing. After the firing, the electrode 3 has been densified with the bonding agent impregnated in it, resulting in improved bonding strength between the joining section 4 and the electrode 3. That is, temperature control during firing achieves the shape retention of the electrode 3 and improves the bonding strength.

The electrode 3 may or may not contain aggregate. The electrode 3 containing aggregate features improved structural stability. The aggregate may be the same as for the above-described honeycomb substrate.

As in this embodiment, when the honeycomb substrate 2, the electrode 3, and the joining section 4 include the matrices 201, 301, and 401, respectively, the honeycomb substrate 2 may have the lowest total concentration of the alkali metal and the alkaline earth metal, followed by the electrode 3 and the joining section 4 in this order. The joining section 4 may have the highest total concentration of the alkali metal and the alkaline earth metal. Correspondingly, the honeycomb substrate 2 tends to have the highest softening point, followed by the electrode 3 and the joining section in this order. Thus, temperature control during firing allows reliable prevention of deformation in the electrode 3 and the honeycomb substrate 2, which needs to have a high degree of shape retention during the firing. Additionally, the bonding agent for forming the joining section easily softens during the firing, thus facilitating densification with the bonding agent partially impregnated in the honeycomb substrate 2 and the electrode 3. The densification sufficiently increases the bonding strength between the honeycomb substrate 2, the joining section 4, and the electrode 3.

The total concentration of the alkali metal and the alkaline earth metal in the electrode 3 can be adjusted as appropriate, for example, within a range of 0.1 mass % to 15 mass %. The total concentration of the alkali metal and the alkaline earth metal in the electrode 3 is preferably lower than that of the joining section 4 by 15 mass % to 50 mass %, and more preferably by 35 mass % to 45 mass %. In this case, the electric resistivity of the electrode 3 can be lowered sufficiently while preventing deformation during firing. The total concentration of the alkali metal and the alkaline earth metal in the honeycomb substrate 2 can also be adjusted as appropriate, and is preferably lower than that of the electrode 3 by 50 mass % to 95 mass %, and more preferably lower by 70 mass % to 92 mass %. In this case, the electric resistivity of the honeycomb substrate 2 can be lowered sufficiently while preventing deformation during firing. The total concentrations of the alkali metal and the alkaline earth metal in the electrode 3 and the honeycomb substrate 2 can be measured with the above-mentioned EPMA.

The electrically heated catalyst 1 in this embodiment can be produced in the same manner as in the first embodiment except that the electrode material is changed. More specifically, the electrode material may be produced, for example, in the same manner as the mixed raw material for the honeycomb substrate in the first embodiment, and, for example, the electrode material may contain more alkali metal and/or alkaline earth metal than those in the mixed raw material for the honeycomb substrate. The mixed raw material for the electrode is kneaded together with a binder and water to prepare the electrode material. The binder may be, for example, an organic binder such as methylcellulose. The binder content may be, for example, about 2% by mass.

The bonding agent for forming the joining section may be produced in the same manner as in the first embodiment, and, for example, the bonding agent may contain more alkali metal and/or alkaline earth metal than those in the mixed raw material for the honeycomb substrate and the mixed raw material for the electrode.

The firing conditions may be the same as in the first embodiment. In the present embodiment, the above-described integrated article may be fired, for example, in air at 700° C. and then, for example, in an atmosphere of inert gas at 1300° C.

### Third Embodiment

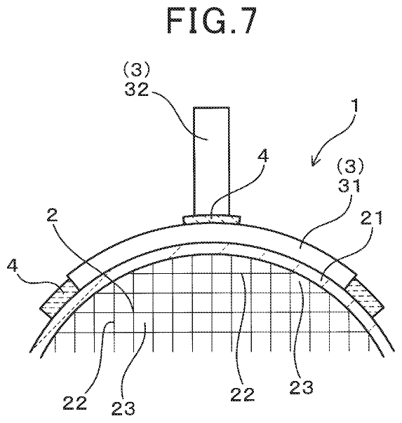

An electrically heated catalyst will now be described including an electrode 3 that is a carbon electrode. As illustrated in FIG. 7, a carbon electrode can be formed as the electrode 3. The other parts of the electrically heated catalyst 1 in the present embodiment may be the same as those in the first embodiment.

The electrode 3 of the electrically heated catalyst 1 in this embodiment is a carbon electrode and thus has a low electrical resistance. Furthermore, the carbon electrode and the resistive heating element material have similar coefficients of thermal expansion, and thus the electrode 3 and the joining section 4 are less likely to crack at their interface. In a case a metal electrode is used, the oxidation of the metal may form a dielectric film on the electrode. However, as in this embodiment, formation of dielectric film on the electrode 3 is prevented by employing a carbon electrode as the electrode 3. This prevents an increase in the electrical resistance due to the formation of a dielectric film. As a result, electrical heating allows electricity to flow through the honeycomb substrate 2 uniformly and sufficiently, thus more reliably preventing generation of temperature distribution.

The carbon electrode is an electrode comprising carbon as a primary component. The phrase “comprising carbon as a primary component” means that the carbon content among components is 50 mass % or more. The carbon content in the carbon electrode is preferably 80 mass % or more, more preferably 90 mass % or more, and still more preferably 95 mass % or more. Most preferably, the carbon electrode consists essentially of carbon. The phrase “consisting essentially of carbon” means consisting of carbon except for unavoidable impurities.

The present disclosure is not limited to the embodiments described above, but applicable to various embodiments without departing from the gist and scope thereof. That is, although the present disclosure has been described based on the embodiments, it is to be understood that the disclosure is not limited to the embodiments and configurations. This disclosure encompasses various modifications and alterations falling within the scope of equivalent. Additionally, various combinations and forms as well as other combinations and forms with one, more than one, or less than one element added thereto also fall within the scope and spirit of the present disclosure.

What is claimed is:

1. An electrically heated catalyst comprising:
a honeycomb substrate;
an electrode formed on the honeycomb substrate; and
a joining section that joins the honeycomb substrate and the electrode together,
wherein the honeycomb substrate and the joining section comprise matrices and conductive filler, and the matrices contain borosilicate including at least one of an alkali metal and an alkaline earth metal.

2. The electrically heated catalyst according to claim 1, wherein
the joining section has a softening point lower than a softening point of the honeycomb substrate.

3. The electrically heated catalyst according to claim 1, wherein
the joining section contains the alkali metal and the alkaline earth metal in a total concentration higher than a concentration of the honeycomb substrate.

4. The electrically heated catalyst according to claim 1, wherein
the alkali metal and the alkaline earth metal is at least one selected from the group consisting of Na, Mg, K, Ca, Li, Be, Rb, Sr, Cs, Ba, Fr, and Ra.

5. The electrically heated catalyst according to claim 1, wherein
the honeycomb substrate has a porosity lower than 20%.

6. The electrically heated catalyst according to claim 1, wherein
the electrode is a resistive heating electrode comprising a matrix and conductive filler, and the matrix contains borosilicate including at least one of an alkali metal and an alkaline earth metal.

7. The electrically heated catalyst according to claim 6, wherein
the electrode contains the alkali metal and the alkaline earth metal in a total concentration higher than the concentration of the honeycomb substrate.

8. The electrically heated catalyst according to claim 1, wherein
the electrode is a carbon electrode.

9. The electrically heated catalyst according to claim 1, wherein
the honeycomb substrate further contains aggregates.
